(19) United States
(12) Patent Application Publication
(10) Pub. No.: US 2005/0206439 A1
(43) Pub. Date: Sep. 22, 2005

(54) Low quiescent current radio frequency switch decoder

(75) Inventor: Wayne M. Struble, Franklin, MA (US)

Correspondence Address: BEVER HOFFMAN & HARMS, LLP;TRI-VALLEY OFFICE, 1432 CONCANNON BLVD., BLDG. G, LIVERMORE, CA, 94550, US

(73) Assignee: TriQuint Semiconductor, Inc., Hillsboro, OR (US)

(21) Appl. No.: 11/081,503

(22) Filed: Mar. 17, 2005

Related U.S. Application Data
(60) Provisional application No. 60/555,738, filed on Mar. 22, 2004.

(51) Int. Cl. H01P 1/15

(52) U.S. Cl. 327/427; 333/103

(57) ABSTRACT

Decoder logic for an RF switch includes first and second enhancement mode transistors and a depletion mode transistor. Sources of the depletion mode transistor and the first enhancement mode transistor are coupled to a VDD supply. The drain and gate of the depletion mode transistor are coupled to the gate of the first enhancement mode transistor. The second enhancement mode transistor is coupled between ground and the drain of the depletion mode transistor. In active mode, the second enhancement mode transistor is turned off and the depletion mode transistor applies a high voltage to the gate of the first enhancement mode transistor, thereby turning on the first enhancement mode transistor to couple the RF switch the V_{DD} supply. In inactive mode, the second enhancement mode transistor is turned on, thereby turning off the first enhancement mode transistor and providing a low current path between the V_{DD} supply terminal and ground.

### FIELD OF THE INVENTION

The present invention relates to a radio frequency (RF) switch and an associated logic decoder, wherein the logic decoder exhibits a low quiescent current.

### RELATED ART

FIG. 1 is a circuit diagram of a conventional single pole, four throw (SP4T) high-power field effect transistor (FET) RF switch 100, which is typically used in a wireless device, such as a cell phone. RF switch 100 includes resistors 110-113, 120-123, 130-133, 140-143 and 150-154, capacitors 160-164 and n-channel field effect transistors 114-116, 124-126, 134-136 and 144-146, which are connected as illustrated. RF sources 171-174 are coupled to corresponding input ports PORT₁-PORT₄ of RF switch 100. Resistors 110-113 and transistors 114-116 form a first switch element 191; resistors 120-123 and transistors 124-126 form a second switch element 192; resistors 130-133 and transistors 134-136 form a third switch element 193; and resistors 140-143 and transistors 144-146 form a fourth switch element 194.

As illustrated in FIG. 1, one control line is typically required for each pole in RF switch 100. Thus, the SP4T RF switch 100 receives control voltages V_{C1}-V_{C4} on four corresponding control lines. During normal operation, one (or none) of the switch elements 191-194 is enabled. To enable one of the switch elements 191-194, a corresponding DC control voltage V_{C1}-V_{C4} is activated, thereby turning on an associated set of switch transistors 114-116, 124-126, 134-125 or 144-146. For example, switch element 191 may be enabled by activating DC control voltage V_{C1}. The activated control voltage V_{C1} turns on transistors 114-116 (via resistors 110-113), thereby allowing an RF signal from RF source 171 to be routed through input resistor 151, input capacitor 161, transistors 114-116 to the antenna, output capacitor 160 and load resistor 150. In this example, the DC control voltages V_{C2}-V_{C4} are deactivated, such that switch elements 191-194 are disabled.

The activated control voltage (e.g., V_{C1}) is typically derived from a system voltage supply. For example, the activated control voltage V_{C1} may have a nominal value of about 2.5 Volts. When the control voltage V_{C1} is activated, a small DC control current I_{C1} flows through resistor 110 (to resistors 111-113).

Note that the required switch control voltages V_{C1}-V_{C4} are not generally compatible with the logic voltages or states available from the base-band or power control chips in the associated wireless device. As a result, CMOS logic decoders have been used to translate the available logic states and voltages from the base-band chips to the logic states and voltages required by RF switch 100. CMOS logic decoders have been used because these decoders do not draw static DC current during any given state of RF switch 100. Thus, the CMOS logic decoders do not negatively impact the battery life of the wireless device. For performance reasons, the semiconductor technology used for the CMOS logic decoder is silicon based, whereas the semiconductor technology used for RF switch 100 is typically gallium arsenide (GaAs) based. More specifically, the RF switch is typically fabricated using GaAs metal semiconductor field effect transistors (MESFETs) or pseudomorphic high electron mobility transistors (PHEMTs). As a result of these incompatible fabrication processes, the RF switch and the CMOS logic decoders are fabricated on separate chips, thereby resulting in a two-chip device.

It would therefore be desirable, for both size and cost reasons, to be able to implement an RF switch and the associated decoder logic on a single chip.

An RF switch and the associated decoder logic have been fabricated on a single chip using enhancement-depletion mode MESFET semiconductor technology (or enhancement-depletion mode PHEMT semiconductor technology). The enhancement mode (normally off) transistors are used to perform the logic decoder functions, and the depletion mode (normally on) transistors are used to perform the RF switch functions. However, a conventional 3-Watt high power SP4T RF switch with an on-chip logic decoder undesirably draws a static DC current (I_{DD}) between 300-1000 microAmps using prior art enhancement-depletion mode logic. This conventional RF switch also exhibits a relatively slow switching speed, on the order of 1.27 microseconds. Such an RF switch and the associated on-chip decoder logic are described in more detail below.

FIG. 2 is a circuit diagram of RF switch 100 and conventional on-chip decoder logic 200, fabricated with enhancement-depletion mode technology. Decoder logic 200 includes inverters 201-202 and NOR gates 211-214, which are connected as illustrated. NOR gates 211-214 provide the switch control voltages V_{C1}-V_{C4}, respectively, in response to the input signals VA and VB.

FIG. 3 is a circuit diagram of conventional NOR gate 211, which includes depletion mode (normally on) transistor 301 and enhancement mode (normally off) transistors 302-303, which are connected as illustrated. In the present application, enhancement mode transistors are identified by the letter “E” enclosed by a dashed circle, while depletion mode transistors are identified by the letter “D” enclosed by a dashed circle. NOR gates 212-214 are identical to NOR gate 211. FIG. 4 is a graph 400 illustrating the transfer characteristic of NOR gate 211. FIG. 5 is a waveform diagram 500 illustrating the input voltages V_{A} and V_{B} and the resulting switch control voltage V_{C1}.

When both input voltages V_{A} and V_{B} have a logic low state (i.e., voltages V_{A} and V_{B} are less than the threshold voltage (V_{T}) of the associated enhancement mode transistors 302 and 303), the enhancement mode transistors 302 and 303 are both turned off. Under these conditions, depletion mode transistor 301 provides the V_{DD} supply voltage as the voltage control signal V_{C1}. Depletion mode transistor 301 provides a current (I_{S}) in response to the load presented by switch element 191. Depletion mode transistor 301 must be sized large enough to supply the largest anticipated load current required by switch element 191, with a sufficient switching speed. As a result, depletion mode transistor 301 is a relatively large transistor, which must supply a minimum of 60 to 80 microAmps of current. (In the example illustrated by FIG. 4, switch element 191 is modeled as an infinite impedance load, such that the total I_{DD} supply current provided under these conditions is equal to 0 Amps. However, it is understood that switch element 191 represents a finite impedance load, such that the I_{DD} supply current is greater than 0 Amps.)

When one or both of the input voltages V_{A} and V_{B} has a logic high state (i.e., greater than V_{T}), one or more of the associated enhancement mode transistors 302 and 303 is turned on. Under these conditions, the turned on enhancement mode transistor(s) pulls down the switch control voltage V_{C1} to the ground supply voltage, thereby disabling the associated switch element 191. In addition, the turned on enhancement mode transistor(s) create a conductive path (or paths) between the V_{DD} supply voltage terminal and the ground supply terminal. Because of the relatively large size of depletion mode transistor 301 (which contributes a current on the order of 60 to 80 microAmps), the total I_{DD} supply current has a relatively large value (I_{S1}), on the order of 300 microAmperes to 1 milliAmpere, under these conditions. This current (I_{S1}) is always drawn from the V_{DD} supply when the control voltage V_{C1} has a logic low state.

As illustrated in FIG. 5 (wherein the V_{DD} supply voltage is equal to 2.5 Volts), the large depletion mode transistor 301 results in a large rise time of the V_{C1} control voltage, on the order of 1.27 microseconds. The large depletion mode transistor 301 also results in a fall time of the V_{C1} control voltage on the order of 100 nanoseconds.

It would be desirable to have an RF switch with an on-chip logic decoder having a reduced static DC current and an improved switching speed.

### SUMMARY

Accordingly, the present invention provides an RF switch with on-chip decoder logic having a static DC current draw of about 5 to 10 microAmperes and a switching speed of about 50 nanoseconds. The decoder logic includes an output driver structure (e.g., a NOR gate) having a depletion mode transistor and a plurality of enhancement mode transistors.

In one embodiment, the decoder logic includes a depletion mode transistor, a first enhancement mode transistor and a second enhancement mode transistor. Sources of the depletion mode transistor and the first enhancement mode transistor are coupled to a V_{DD} voltage supply terminal. The drain and gate of the depletion mode transistor are coupled to the gate of the first enhancement mode transistor. The second enhancement mode transistor is coupled between ground and the drain of the depletion mode transistor.

In an active mode, the second enhancement mode transistor is turned off, such that the depletion mode transistor applies a logic high voltage to the gate of the first enhancement mode transistor. As a result, the first enhancement mode transistor is turned on, thereby coupling the RF switch the V_{DD} voltage supply terminal. Because the depletion mode transistor only has to turn on the first enhancement mode transistor, the depletion mode transistor can advantageously be made relatively small.

In an inactive mode, the second enhancement mode transistor is turned on, thereby coupling the gate of the first enhancement mode transistor to ground. As a result, the first enhancement mode transistor is turned off, thereby decoupling the RF switch from the V_{DD} voltage supply terminal. In addition, the turned on second enhancement mode transistor (along with the depletion mode transistor) provide a current path between the V_{DD} supply terminal and ground. However, the small size of the depletion mode transistor ensures that the current along this path is very small with respect to conventional decoder logic.

The present invention will be more fully understood in view of the following description and drawings.

### BRIEF DESCRIPTION OF THE DRAWINGS

FIG. 1 is a circuit diagram of a conventional single pole, four throw (SP4T) high-power field effect transistor (FET) RF switch.

FIG. 2 is a circuit diagram of a conventional RF switch and on-chip decoder logic, fabricated with enhancement-depletion mode technology.

FIG. 3 is a circuit diagram of conventional NOR gate used in the on-chip decoder logic of FIG. 2.

FIG. 4 is a graph illustrating the transfer characteristic of the NOR gate of FIG. 3.

FIG. 5 is a waveform diagram illustrating the input voltages V_{A} and V_{B} applied to the NOR gate of FIG. 3, and the resulting switch control voltage V_{C1} provided by the NOR gate of FIG. 3.

FIG. 6 is a circuit diagram of an RF switch and on-chip decoder logic, in accordance with one embodiment of the present invention.

FIG. 7 is a circuit diagram of a 2-input NOR gate in accordance with one embodiment of the present invention.

FIG. 8 is a graph illustrating the transfer characteristic of the NOR gate of FIG. 7 in accordance with one embodiment of the present invention.

FIG. 9 is a waveform diagram illustrating the input voltages V_{A} and V_{B} and the resulting switch control voltage V_{C1} of the NOR gate of FIG. 7 in accordance with one embodiment of the present invention.

FIG. 10 is a layout diagram of a semiconductor chip that includes the RF switch and decoder logic of FIG. 6 in accordance with one embodiment of the present invention.

FIGS. 11, 12, 13 and 14 are waveform diagrams illustrating the control signals V_{C1}, V_{C2}, V_{C3} and V_{C4}, respectively, provided by the decoder logic of FIG. 6.

FIG. 15 is a graph illustrating the insertion loss and return loss at various frequencies for the transmit modes of the decoder logic of FIG. 6.

FIG. 16 is a graph illustrating the insertion loss and return loss at various frequencies for the receive modes of the decoder logic of FIG. 6.

FIG. 17 is a graph illustrating the transmit-to-receive isolation at various frequencies for the transmit modes of the decoder logic of FIG. 6.

FIG. 18 is a graph illustrating the transmit-to-transmit isolation at various frequencies for the transmit modes of the decoder logic of FIG. 6.

FIG. 19 is a graph illustrating the receive-to-receive isolation at various frequencies for the receive modes of the decoder logic of FIG. 6.

FIGS. 20, 21, 22 and 23 are graphs illustrating second harmonics (H2), third harmonics (H3), and insertion loss for operation at 836.5 MHz (+25° C.), 897.5 MHz (+25° C.), 1747.5 MHz (+25° C.) and 1880 MHz (+25° C.), respectively, in accordance with the present invention.

FIGS. 24, 25, 26 and 27 are graphs illustrating decoder supply current for operation at 836.5 MHz (+25° C.), 897.5 MHz (+25° C.), 1747.5 MHz (+25° C.) and 1880 MHz (+25° C.), respectively, in accordance with the present invention.

FIG. 28 is a circuit diagram of modified decoder logic used to control a SP3T RF switch in accordance with another embodiment of the present invention.

FIG. 29 is a circuit diagram of modified decoder logic used to control a SP6T RF switch in accordance with another embodiment of the present invention.

FIG. 30 is a circuit diagram of a 3-input NOR gate in accordance with one embodiment of the present invention.

FIG. 31 is a circuit diagram of an output buffer in accordance with another embodiment of the present invention.

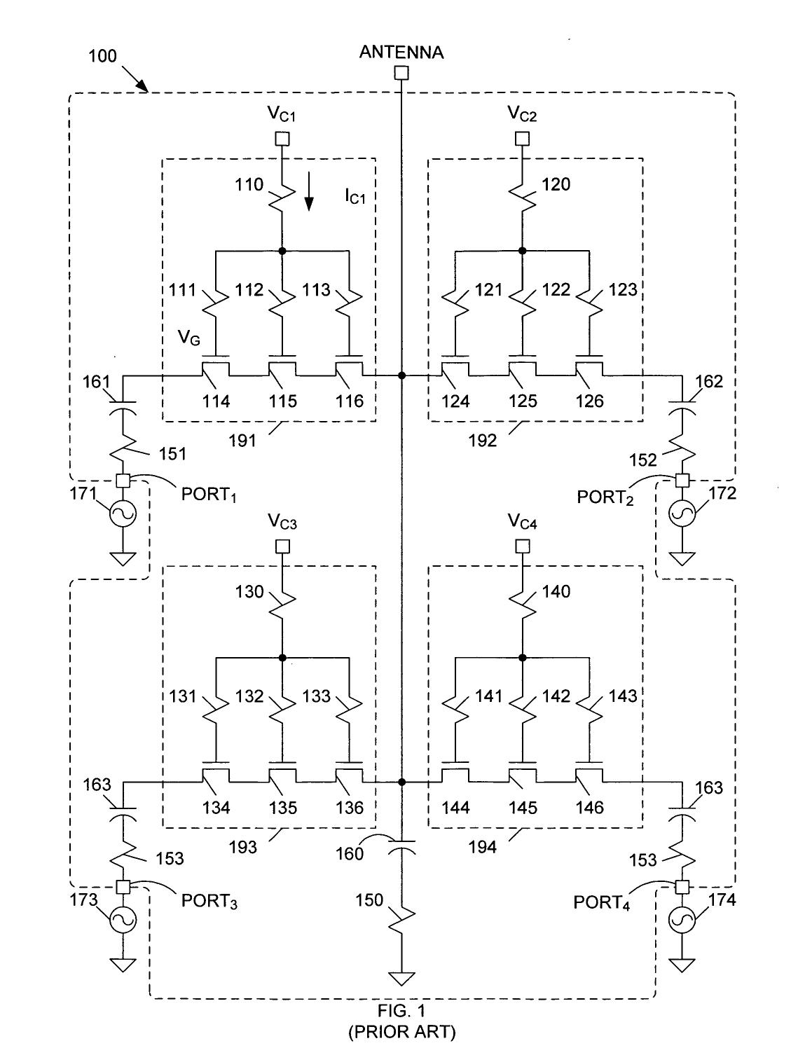

### DETAILED DESCRIPTION

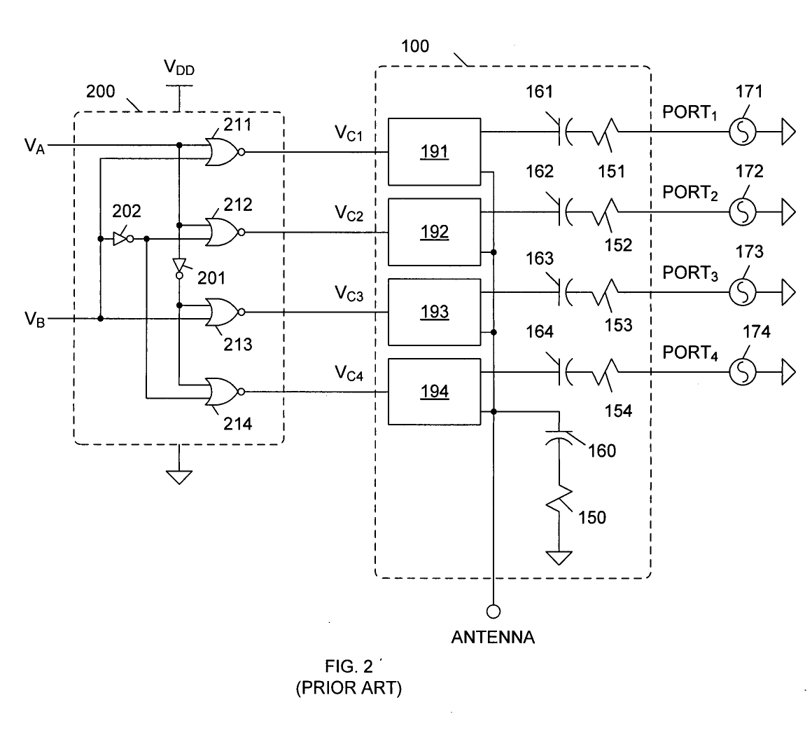

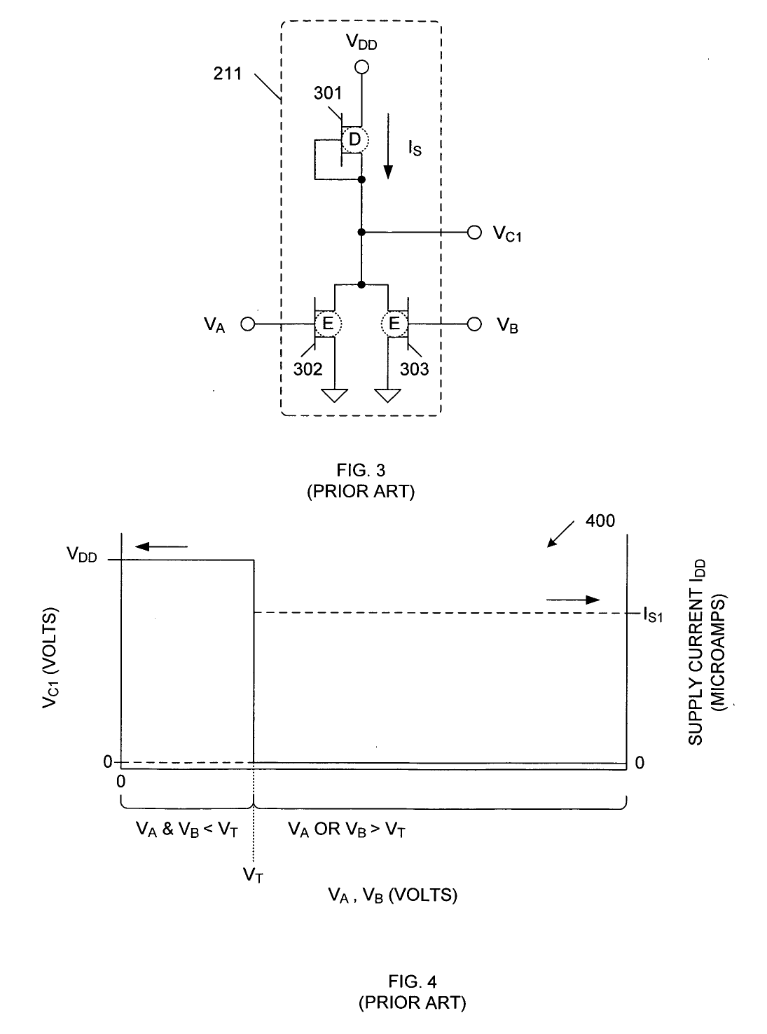

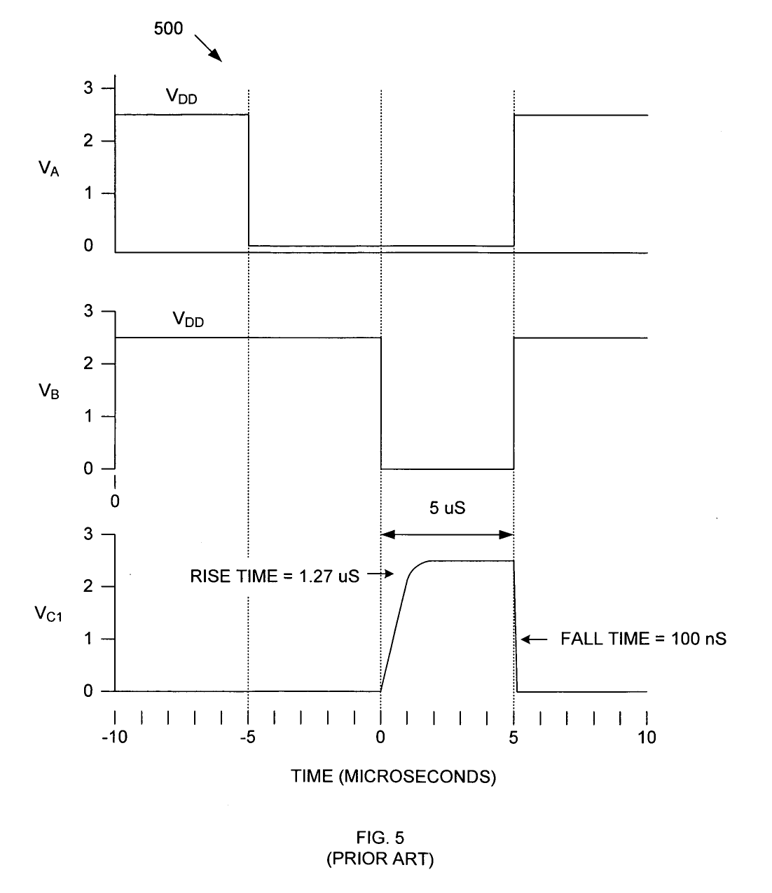

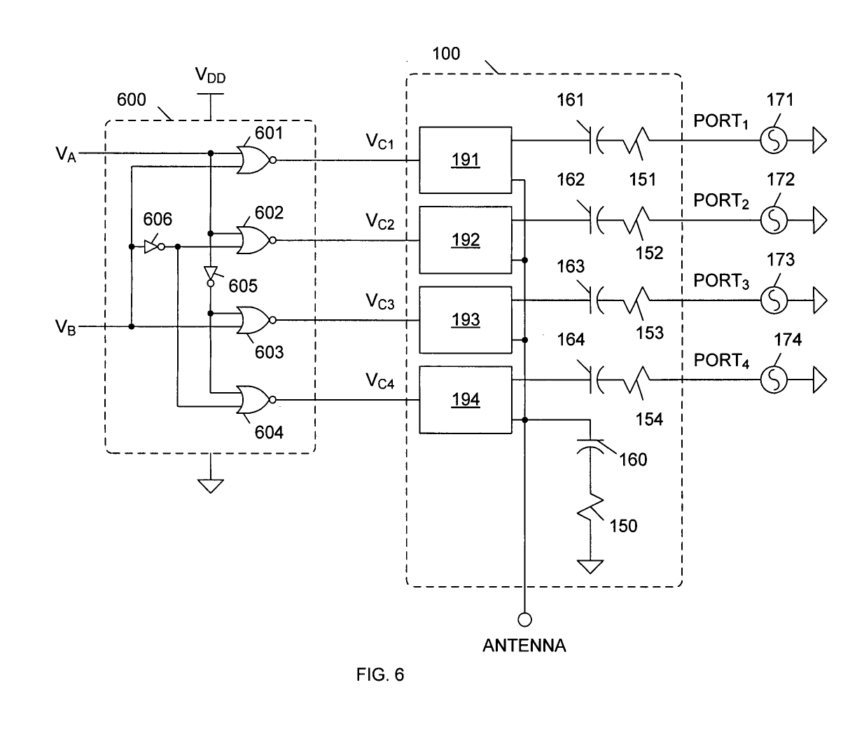

FIG. 6 is a circuit diagram of RF switch 100 and on-chip decoder logic 600, in accordance with one embodiment of the present invention. Decoder logic 600 includes NOR gates 601-604 and inverters 605-606, which are connected as illustrated to implement a 2-to-4 decoder. Decoder logic 600 is fabricated on the same chip as RF switch 100, using enhancement-depletion mode MESFET semiconductor technology (or enhancement-depletion mode PHEMT semiconductor technology). In the described embodiment, decoder logic and RF switch 100 are fabricated using a GaAs process technology. NOR gate 601 provides the switch control voltage V_{C1} in response to the input signals V_{A} and V_{B}. NOR gate 602 provides the switch control voltage Vc₂ in response to the input signal V_{A} and the inverse of the input signal V_{B} (as provided by inverter 606). NOR gate 603 provides the switch control voltage V_{C3} in response to the input signal V_{B} and the inverse of the input signal V_{A} (as provided by inverter 605). NOR gate 604 provides the switch control voltage V_{C4} in response to the inverse of input signal V_{A} and the inverse of the input signal V_{B}. The differences between decoder logic 600 (FIG. 6) and decoder logic 200 (FIG. 2), which are described in more detail below, are found in the construction of NOR gates 601-604.

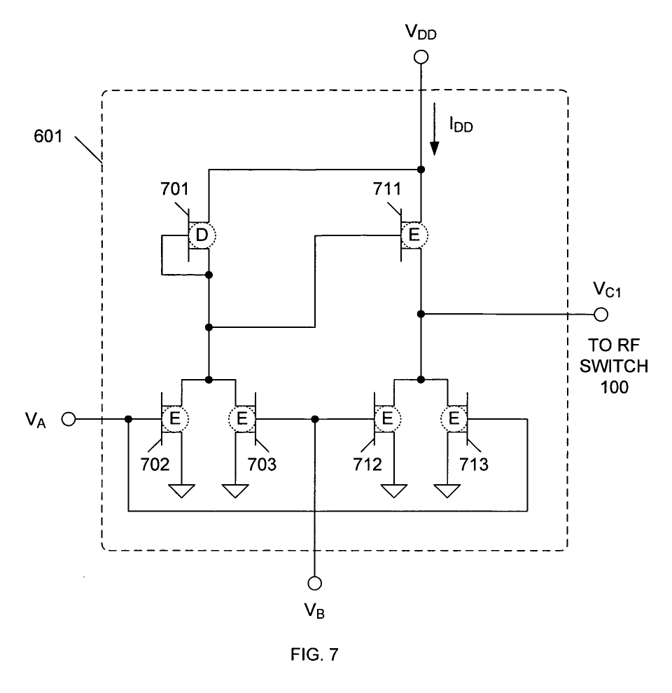

FIG. 7 is a circuit diagram of 2-input NOR gate 601 in accordance with one embodiment of the present invention. NOR gates 602, 603 and 604 are identical to NOR gate 601 in the present embodiment.

NOR gate 601 includes depletion mode (normally on) transistor 701 and enhancement mode (normally off) transistors 702-703 and 711-713. The source regions of depletion mode transistor 701 and enhancement mode transistor 711 are coupled to the V_{DD} supply voltage terminal. The drain of depletion mode transistor 701 is coupled to: the gate of depletion mode transistor 701, the drains of enhancement mode transistors 702 and 703, and the gate of enhancement mode transistor 711. The drain of enhancement mode transistor 711 is coupled to: switch element 191 (i.e., V_{C1} control voltage terminal), and the drains of enhancement mode transistors 712 and 713. The sources of enhancement mode transistors 702-703 and 712-713 are coupled to the ground supply terminal. The gates of enhancement mode transistors 702 and 713 are coupled to receive the input voltage V_{A}, and the gates of enhancement mode transistors 703 and 712 are coupled to receive the input voltage V_{B}.

When both input voltages V_{A} and V_{B} have a logic low state (i.e., voltages V_{A} and V_{B} are less than the threshold voltage (V_{T}) of the associated enhancement mode transistors 702-703 and 712-713), the enhancement mode transistors 702-703 and 712-713 are all turned off. Also under these conditions, depletion mode transistor 701 is turned on, thereby providing the V_{DD} supply voltage to the gate of enhancement mode transistor 711. As a result, enhancement mode transistor 711 is turned on, such that this transistor 711 provides the V_{DD} supply voltage, minus the threshold voltage V_{TH} of transistor 711, to the associated switch element 191 of RF switch 100 as the control voltage V_{C1}.

Depletion mode transistor 701 can be implemented by a single gate or multi-gate depletion mode transistor. The current provided by depletion mode transistor 701 can be relatively small due to the high impedance load (i.e., the gate of enhancement mode transistor 711) driven by this transistor 701. In the described embodiment, depletion mode transistor 701 is only required to provide a current of about 5 to 10 microAmps in order to turn on enhancement mode transistor 711. Thus, depletion mode transistor 701 can be a relatively small transistor. In one embodiment, depletion mode transistor 701 is a 2 micron wide×80 gate transistor.

When turned on, enhancement mode transistor 711 provides a current in response to the load presented by switch element 191. Thus, enhancement mode transistor 711 is sized large enough to supply the largest anticipated load current required by switch element 191. As a result, enhancement mode transistor 711 is a relatively large transistor. In one embodiment, enhancement mode transistor 711 has a width of about 10 microns.

When one or both of the input voltages V_{A} and V_{B} has a logic high state (i.e., greater than V_{T}), one or more of enhancement mode transistors 702-703 is turned on, and one or more of enhancement mode transistors 712-713 is turned on. Under these conditions, the turned on enhancement mode transistor(s) 712-713 pulls down the switch control voltage V_{C1} to the ground supply voltage, thereby disabling the associated switch element 191 in RF switch 100.

In addition, the turned on enhancement mode transistor(s) 702-703 create a conductive path (or paths) between the ground supply voltage and the gate of enhancement mode transistor 711. As a result, enhancement mode transistor 711 is turned off. Consequently, when the switch element 191 is disabled, there is no significant static DC current flowing from the V_{DD} supply terminal to switch element 191 through enhancement mode transistor 711.

The turned on enhancement mode transistor(s) 702-703, along with the turned on depletion mode transistor 701, also create a conductive path (or paths) between the V_{DD} supply voltage terminal and the ground supply terminal. However, because of the relatively small size of depletion mode transistor 701, the I_{DD} supply current has a relatively small value (I_{S2}), on the order of 5 to 10 microAmps, under these conditions. While this current (I_{S2}) is always drawn from the V_{DD} voltage supply when the control voltage V_{C1} has a logic low state, it is noted that this current I_{S2} is significantly lower than the current I_{S1} of the prior art. More specifically, the current I_{S2} of the present invention represents a reduction of 20 to 50 percent of the current I_{S1} of the prior art.

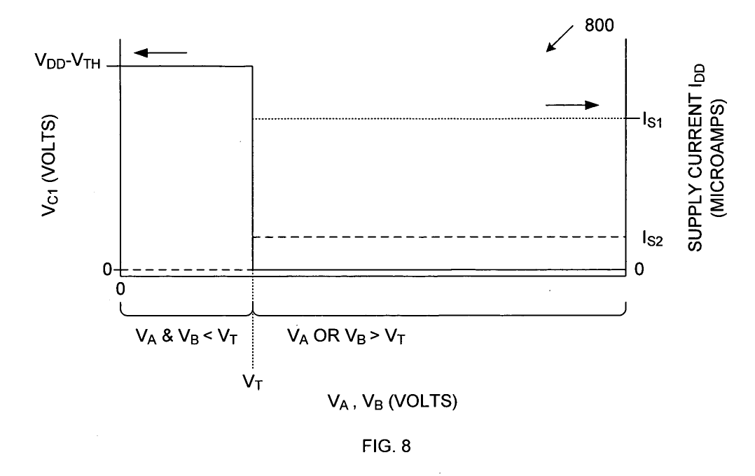

FIG. 8 is a graph 800 illustrating the transfer characteristic of NOR gate 601. Note that graph 800 illustrates both the current I_{S1} associated with prior art NOR gate 211, and the current I_{S2} associated with NOR gate 601 of the present invention. (In the example illustrated by FIG. 8, switch element 191 is modeled as an infinite impedance load, such that the I_{DD} supply current provided under these conditions is equal to 0 Amps. However, it is understood that switch element 191 represents a finite impedance load, such that the I_{DD} supply current is greater than 0 Amps.)

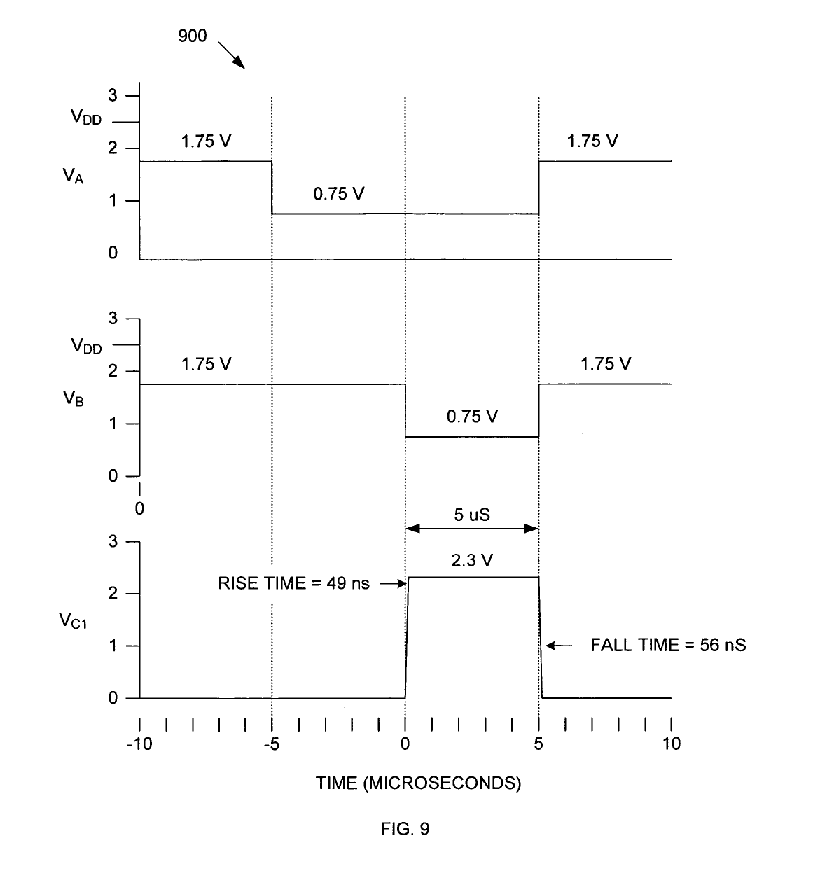

FIG. 9 is a waveform diagram 900 illustrating the input voltages V_{A} and V_{B} and the resulting switch control voltage V_{C1} of NOR gate 601. In waveform diagram 900, the V_{DD} supply voltage is 2.5 volts, the input voltages V_{A} and V_{B} vary between a high voltage of 1.75 Volts and a low voltage of 0.75 Volts. These voltages are used to illustrate the noise margin of present system, wherein voltages of 1.75 Volts to VDD are logic high voltages, and voltages of 0 Volts to 0.75 Volts are logic low voltages. When both of input voltages V_{A} and V_{B} have a logic low state, the control voltage V_{C1} transitions to a high voltage of about 2.3 Volts, with a rise time of about 49 nanoseconds. Note that the control voltage V_{C1} has a high voltage that is equal to the V_{DD} supply voltage minus the threshold voltage V_{TH} of enhancement mode transistor 711. When one or more of the input voltages V_{A} and/or V_{B} has a logic high state, the control voltage V_{C1} transitions to the ground supply voltage, with a fall time of about 56 nanoseconds.

Thus, NOR gate 601 provides a control voltage V_{C1} having a rise time that is significantly faster than the rise time provided by prior art NOR gate 211 (i.e., 1.27 microseconds). More specifically, NOR gate 601 provides a control voltage V_{C1} having a rise time about 95 percent less than the rise time provided by prior art NOR gate 211.

Similarly, NOR gate 601 provides a control voltage V_{C1} having a fall time that is significantly faster than the fall time provided by prior art NOR gate 211 (i.e., 100 nanoseconds). More specifically, NOR gate 601 provides a control voltage V_{C1} having a fall time about 40 to 50 percent less than the fall time provided by prior art NOR gate 211.

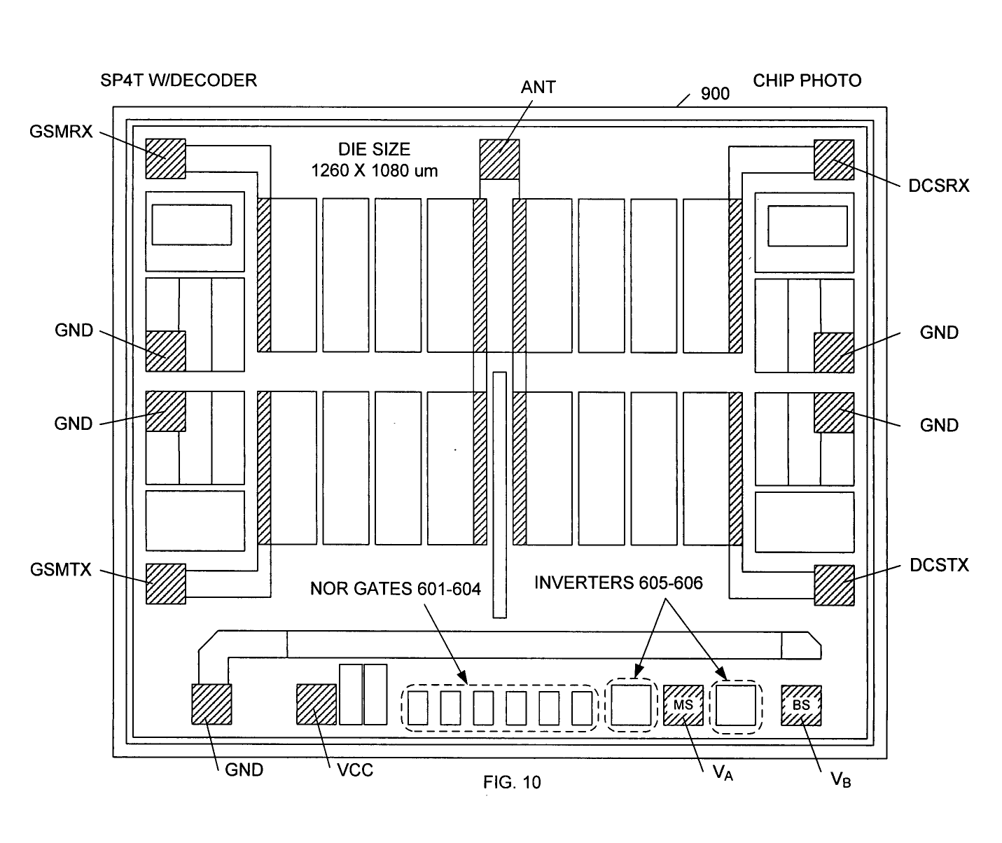

FIG. 10 is a layout diagram of a semiconductor chip 900 that includes RF switch 100 and decoder logic 600. Input voltages V_{A} and V_{B} are provided to mode select pad MS and band select pad BS, respectively, of chip 900. NOR GATES 601-604 and inverters 605-606 provide the V_{C1}-V_{C4} control voltages in response to the input voltages V_{A} and V_{B} in the manner described above. Input ports PORT₁-PORT₄ are labeled GSM RX (GSM receive), GSM TX (GSM transmit), DCS RX (DCS receive) and DCS TX (DCS transmit), respectively. The antenna of RF switch 100 is labeled ANT.

Table 1 below defines four possible configurations of RF switch 100 in response to the input voltages V_{A} and V_{B}. In this example, a logic “1” value is any voltage greater than V_{DD} minus 0.75 Volts, and a logic “0” value is any voltage less than 0.75 Volts.

TABLE 1

| V_{A} (MS) | V_{B} (BS) | GSM RX | DCS RX | GSM TX | DCS TX |
|---|---|---|---|---|---|
| 0 | 0 | ON | OFF | OFF | OFF |
| 0 | 1 | OFF | ON | OFF | OFF |
| 1 | 0 | OFF | OFF | ON | OFF |
| 1 | 1 | OFF | OFF | OFF | ON |

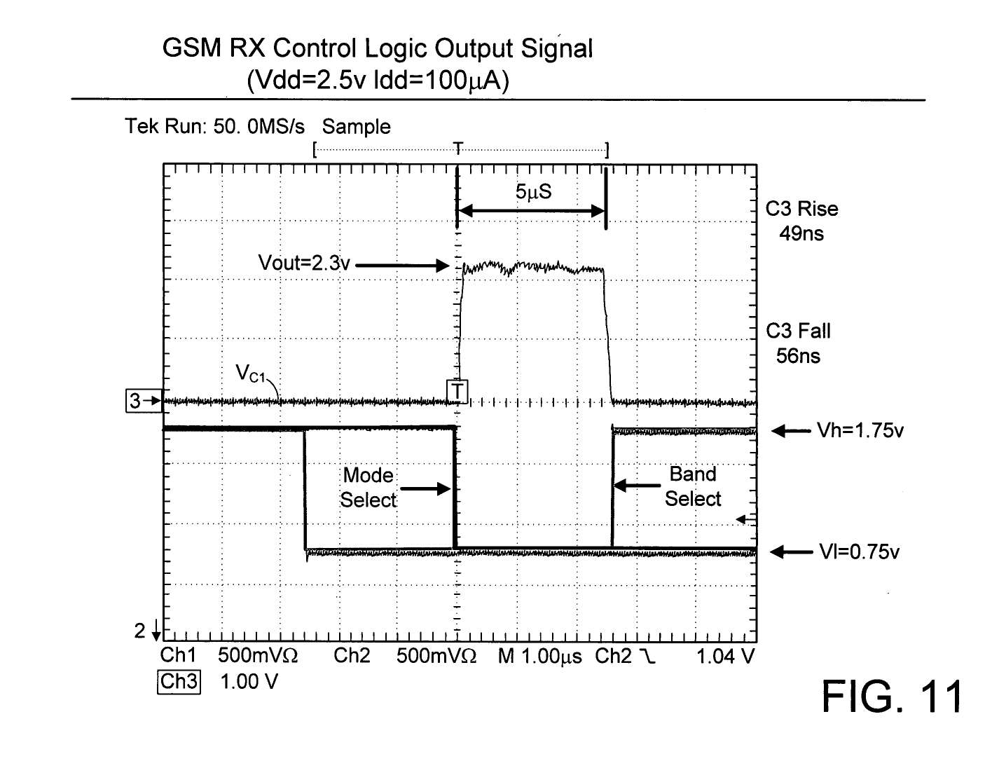

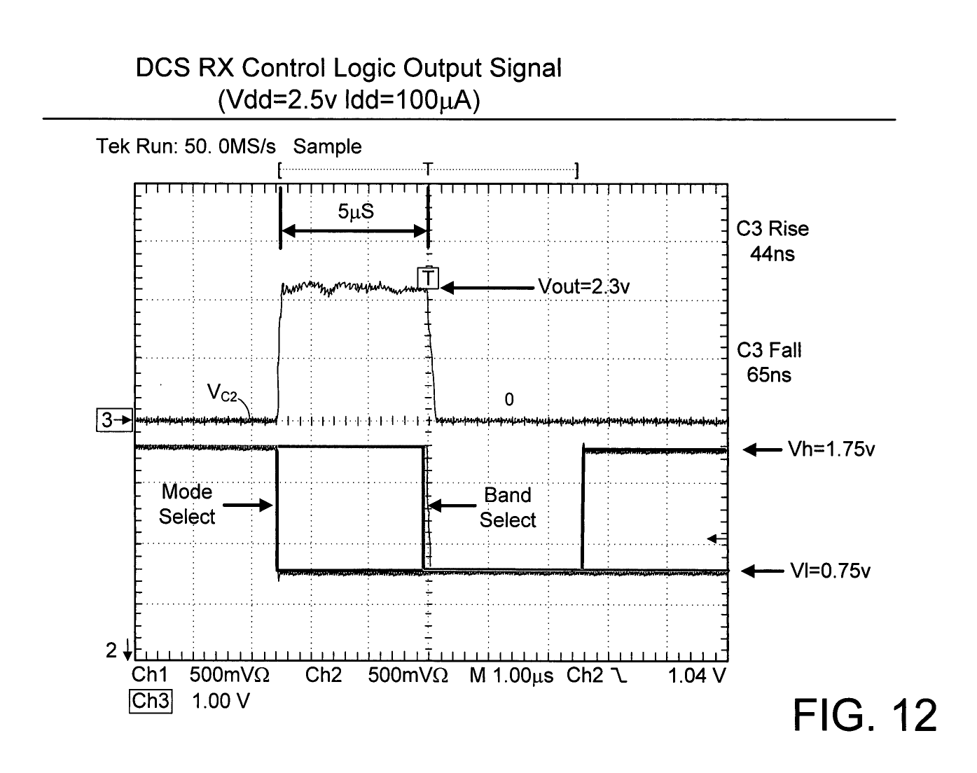

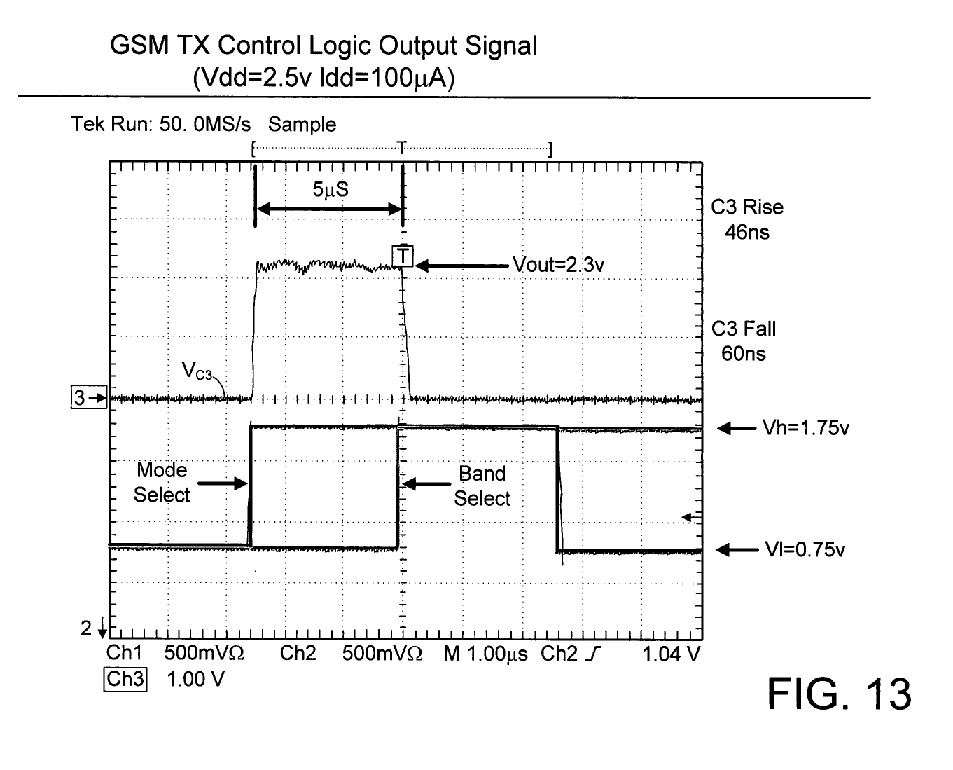

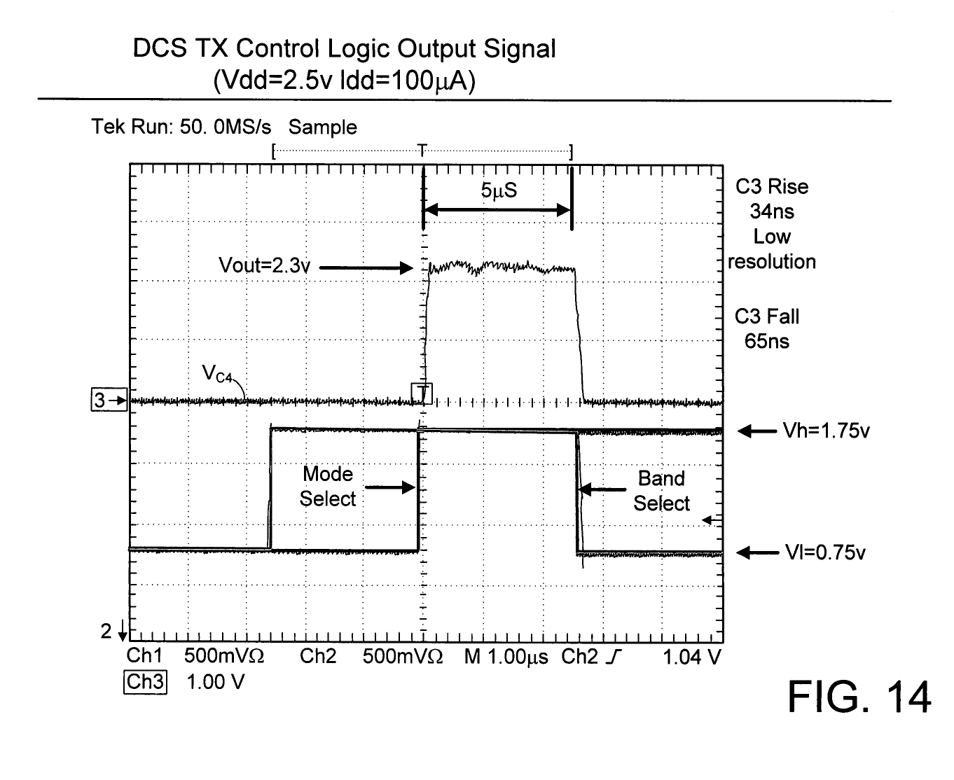

FIGS. 11, 12, 13 and 14 are waveform diagrams illustrating the control signals V_{C1}, V_{C2}, V_{C3} and V_{C4}, respectively, provided during the GSM RX, DCS RX, GSM TX and DCS TX modes, respectively.

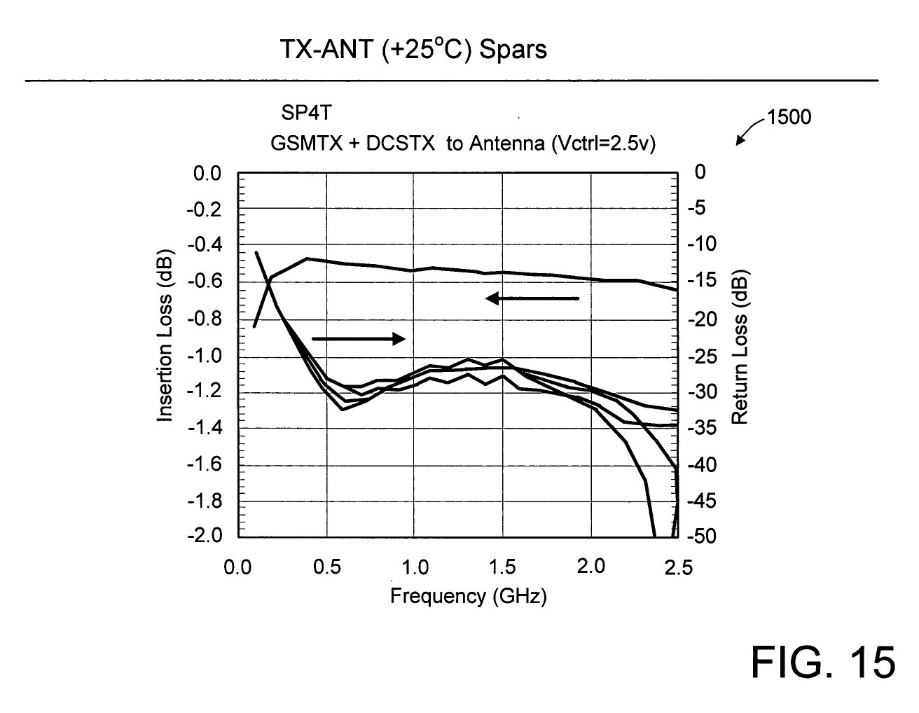

FIG. 15 is a graph 1500 illustrating the insertion loss and return loss for various frequencies for the GSM TX and DCS TX modes of the present invention. The insertion loss and return loss curves of FIG. 15 do not represent any degradation in performance with respect to the prior art.

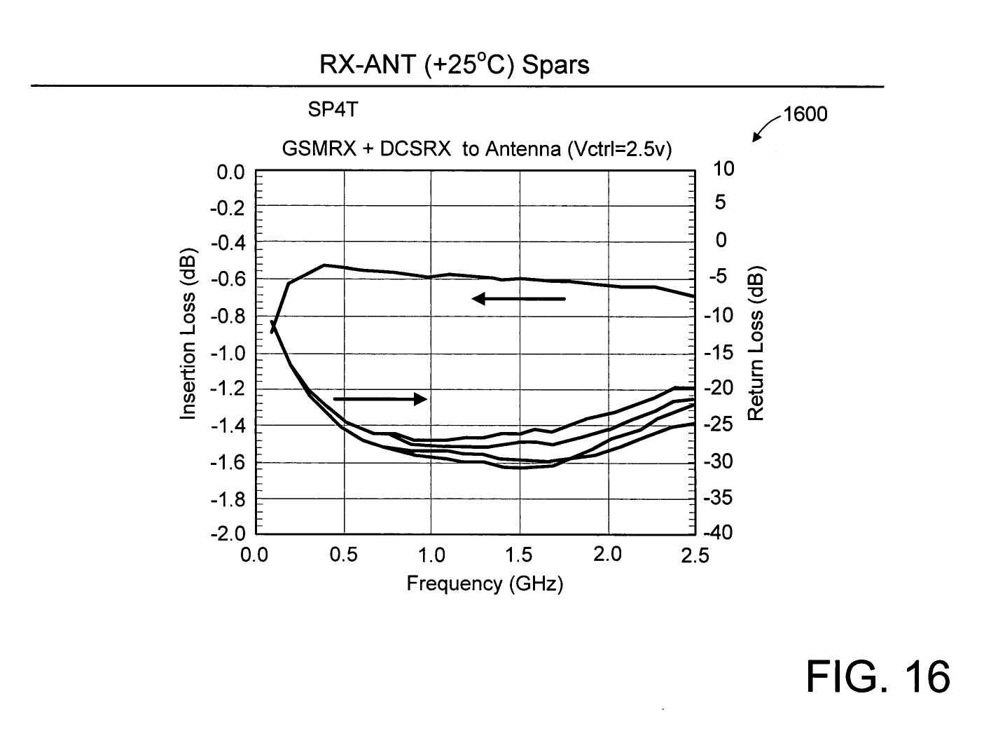

FIG. 16 is a graph 1600 illustrating the insertion loss and return loss for various frequencies for the GSM RX and DCS RX modes of the present invention. The insertion loss and return loss curves of FIG. 16 do not represent any degradation in performance with respect to the prior art.

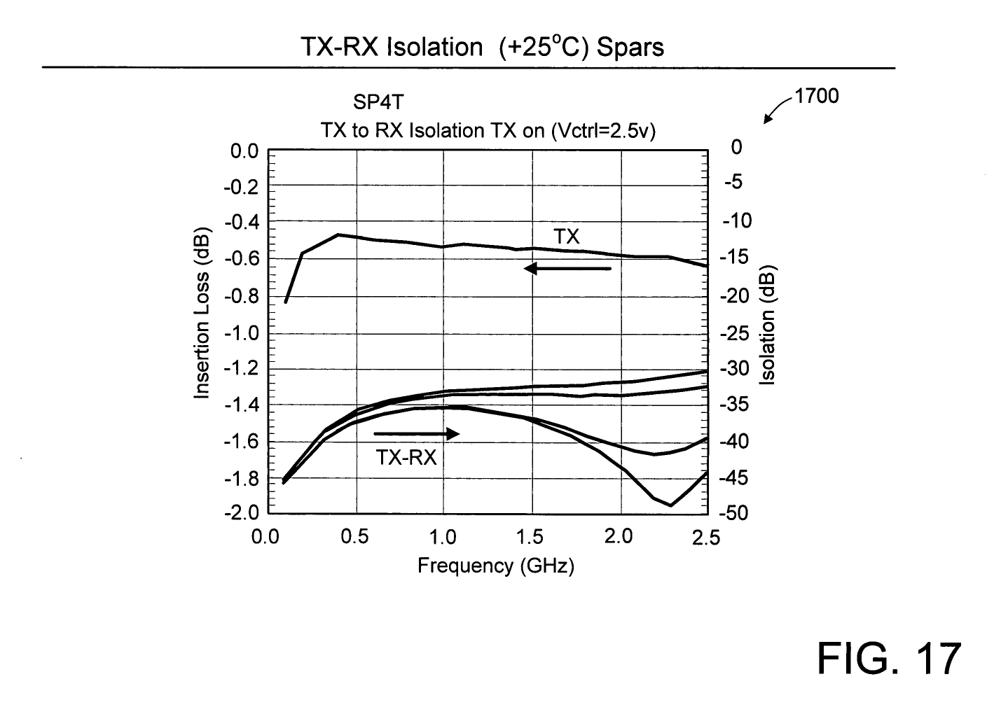

FIG. 17 is a graph 1700 illustrating the transmit-to-receive isolation for various frequencies for the GSM TX and DCS TX modes of the present invention. The four curves in graph 1700 illustrate the leakage to the receive paths (DCS RX and GSM RX) when the transmit paths (DCS TX and GSM TX) are enabled (i.e., leakage to DCS RX path when DCS TX is enabled; leakage to DCS RX path when GSM TX is enabled; leakage to GSM RX path when DCS TX is enabled; and leakage to GSM RX path when GSM TX is enabled). The transmit-to-receive isolation exhibited by the present invention does not represent a degradation in performance with respect to the prior art.

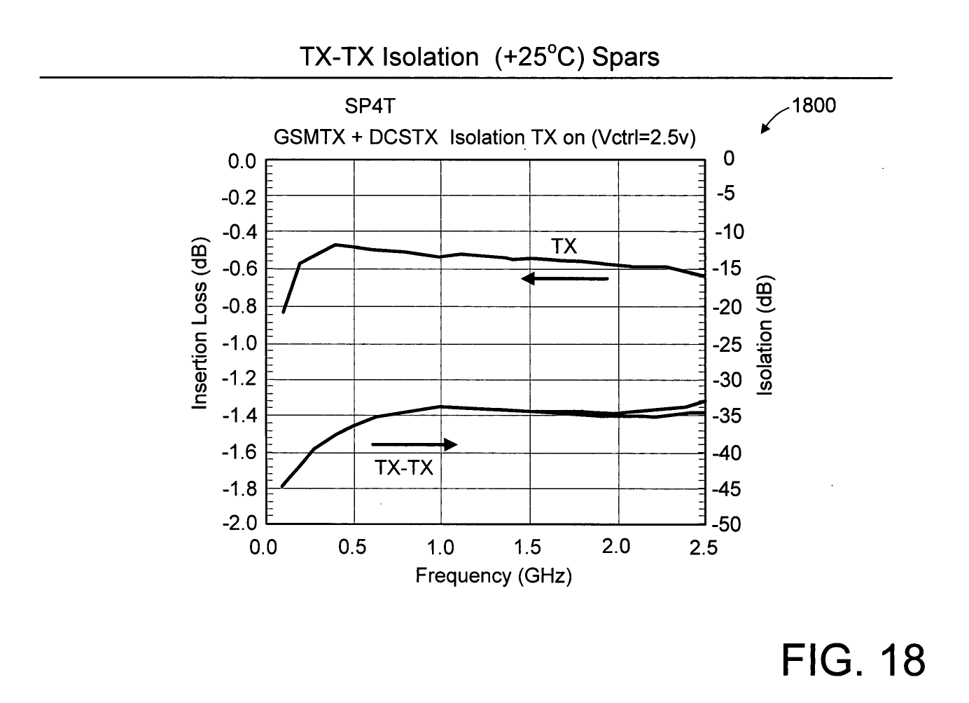

FIG. 18 is a graph 1800 illustrating the transmit-to-transmit isolation for various frequencies for the GSM TX and DCS TX modes of the present invention. The two curves in graph 1800 illustrate the leakages to a transmit path when the other transmit path is enabled (i.e., leakage to DCS TX path when GSM TX is enabled; and leakage to GSM TX path when DCS TX is enabled). The transmit-to-transmit isolation exhibited by the present invention does not represent a degradation in performance with respect to the prior art.

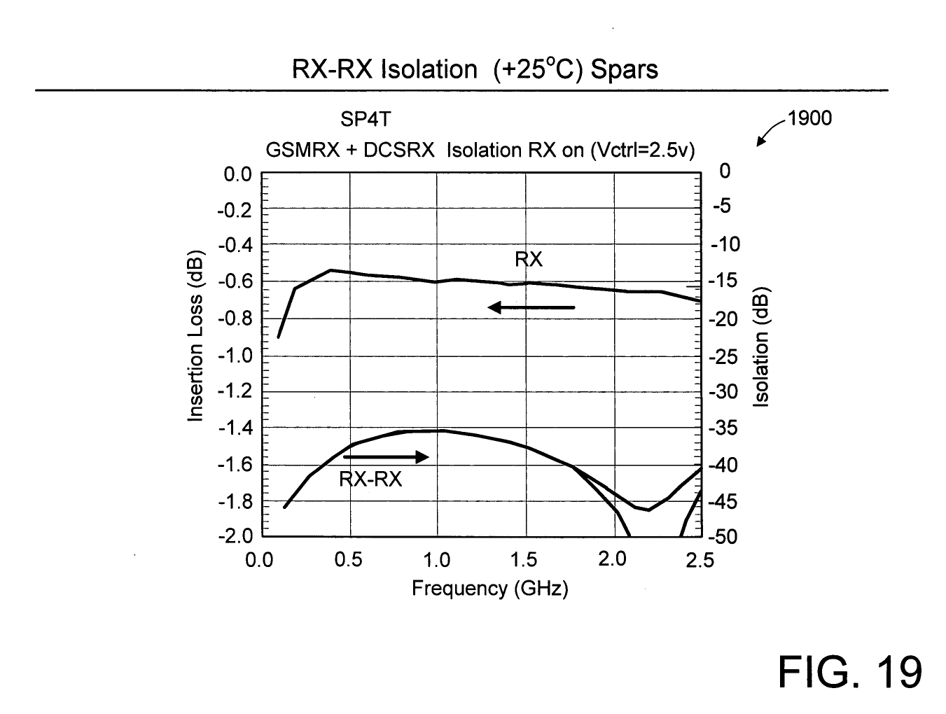

FIG. 19 is a graph 1900 illustrating the receive-to-receive isolation for various frequencies for the GSM RX and DCS RX modes of the present invention. The two curves in graph 1900 illustrate the leakages to a receive path when the other receive path is enabled (i.e., leakage to DCS RX path when GSM RX is enabled; and leakage to GSM RX path when DCS RX is enabled). The receive-to-receive isolation exhibited by the present invention does not represent a degradation in performance with respect to the prior art.

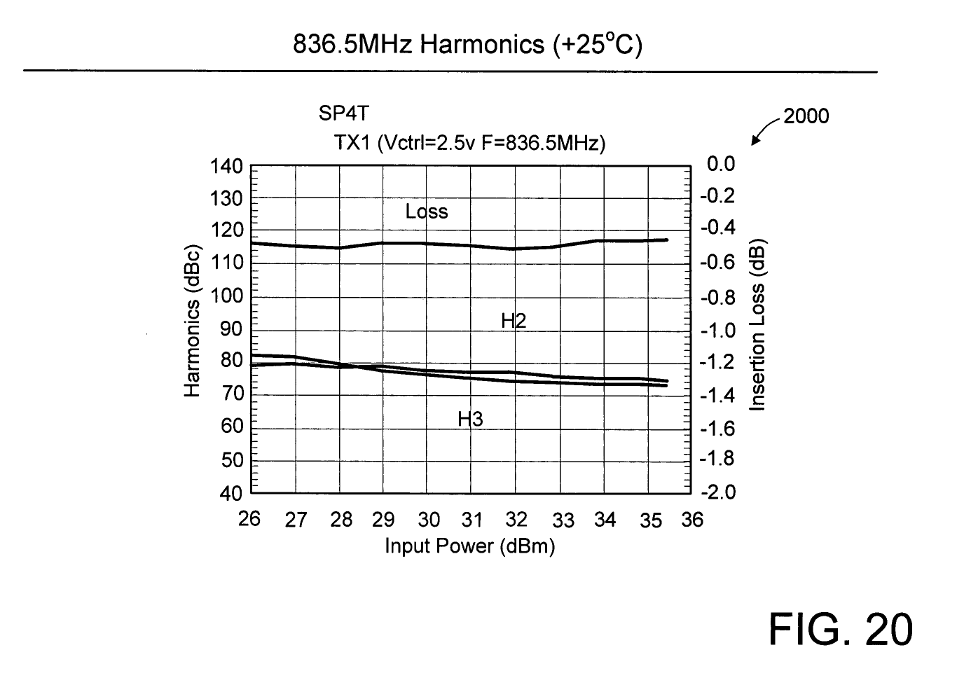

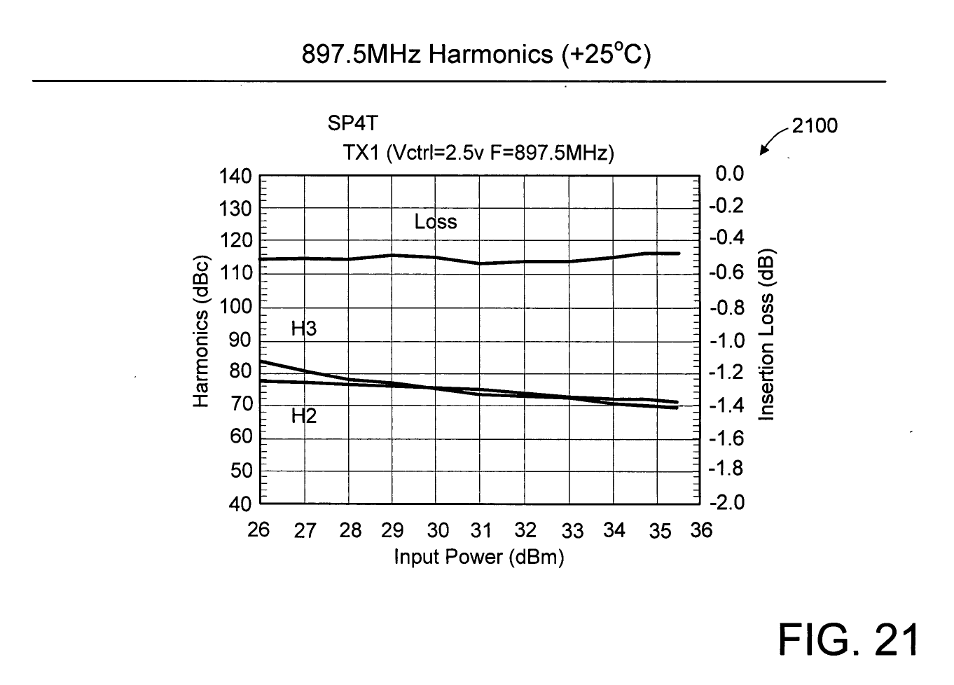

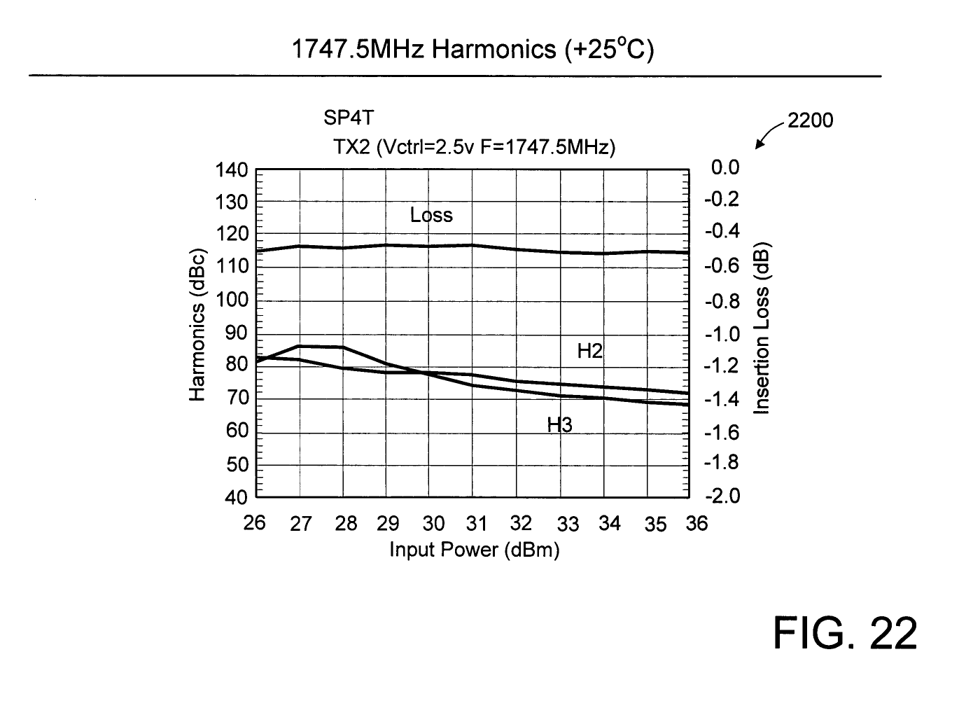

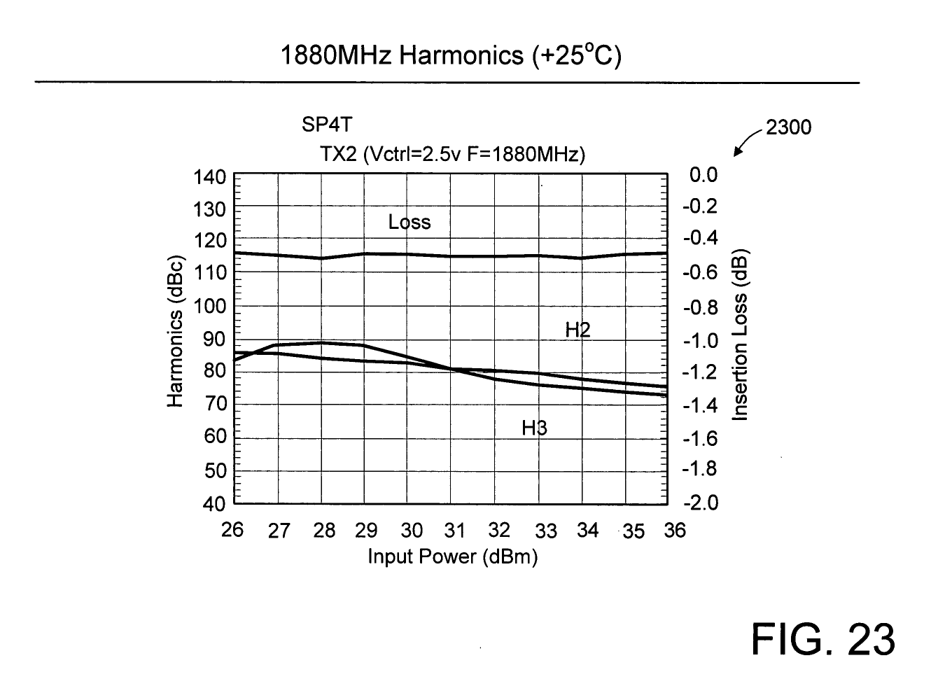

FIGS. 20, 21, 22 and 23 are graphs 2000, 2100, 2200 and 2300, respectively illustrating second harmonics (H2), third harmonics (H3), and insertion loss for operation at 836.5 MHz (+25° C.), 897.5 MHz (+25° C.), 1747.5 MHz (+25° C.) and 1880 MHz (+25° C.), respectively, in accordance with the present invention. The second and third harmonics exhibited by the present invention does not represent a degradation in performance with respect to the prior art.

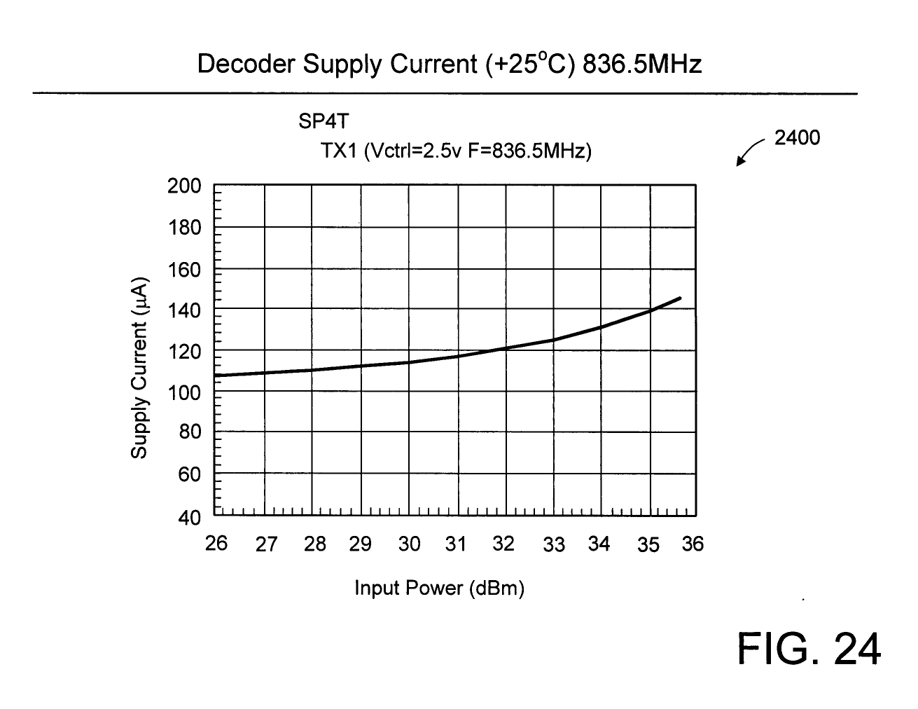

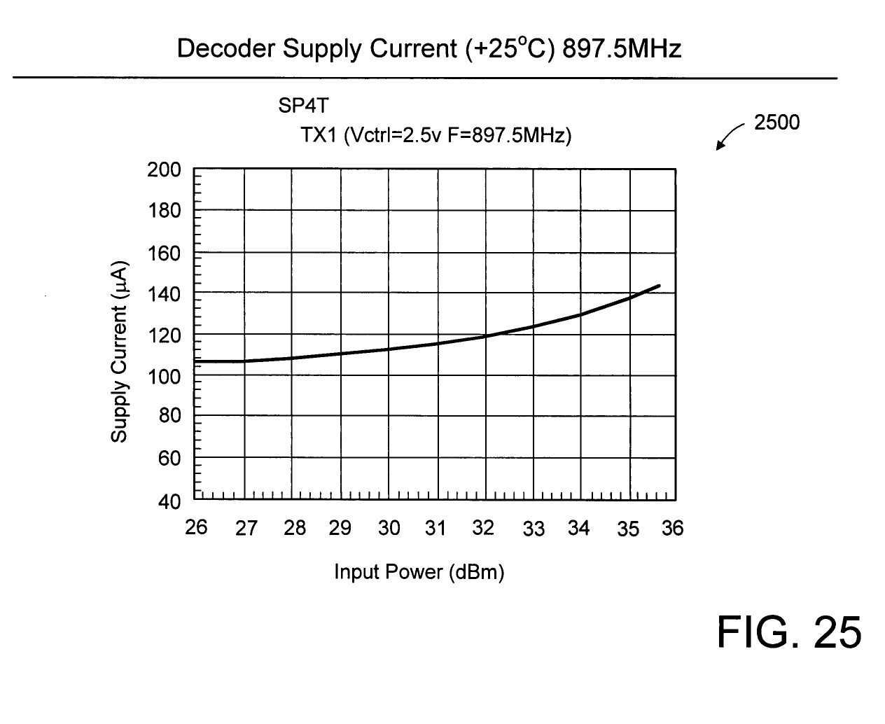

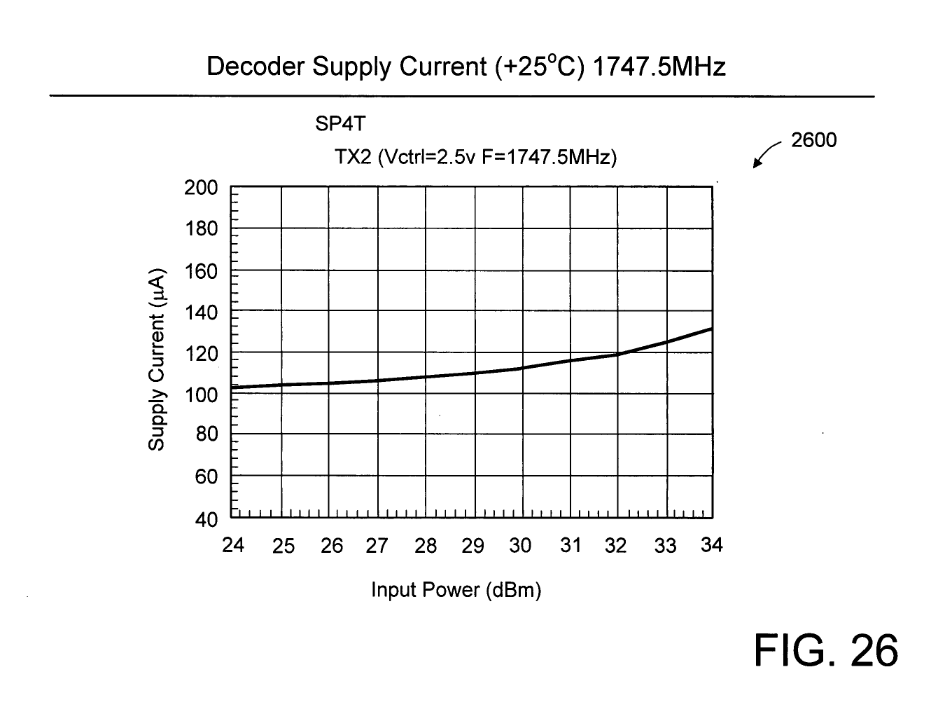

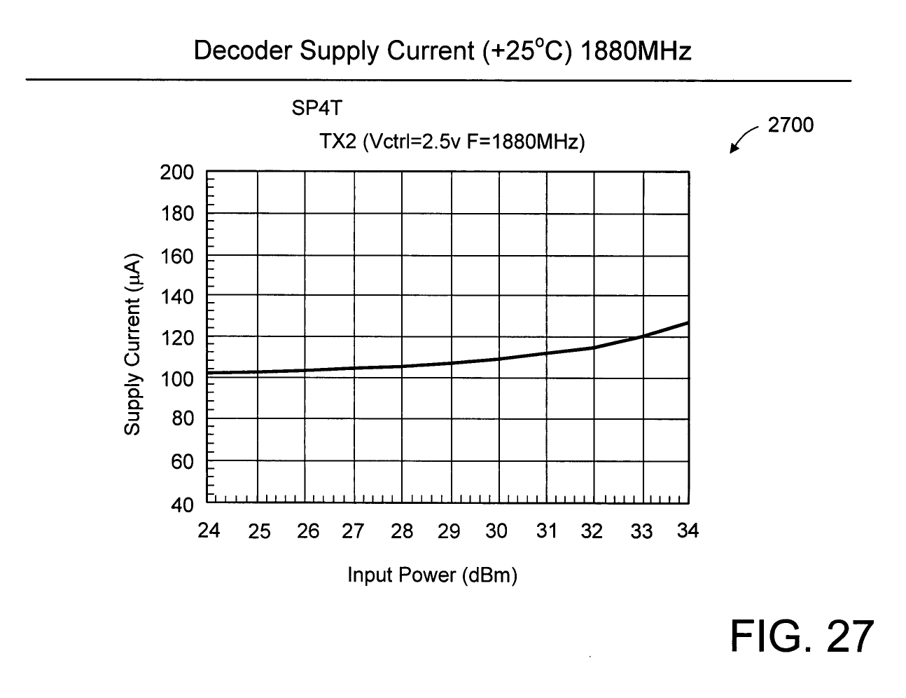

FIGS. 24, 25, 26 and 27 are graphs 2400, 2500, 2600 and 2700, respectively illustrating decoder supply current for operation at 836.5 MHz (+25° C.), 897.5 MHz (+25° C.), 1747.5 MHz (+25° C.) and 1880 MHz (+25° C.), respectively, in accordance with the present invention. The decoder supply current required by the present invention does not represent a degradation in performance with respect to the prior art.

Although the present invention has been described in connection with an SP4T RF switch, it is understood that the decoder logic of the present invention can be modified to control other types of RF switches. For example, decoder logic 600 can be modified to control a single pole, three throw (SP3T) RF switch or a single pole, six throw (SP6T) RF switch.

FIG. 28 is a circuit diagram of modified decoder logic 2800 used to control a SP3T RF switch 2850. Modified decoder logic 2800 (FIG. 28) is similar to decoder logic 600 (FIG. 6). Moreover, SP3T RF switch 2850 (FIG. 28) is similar to SP4T RF switch 100 (FIG. 6). Consequently, similar elements in FIGS. 6 and 28 are labeled with similar reference numbers.

FIG. 29 is a circuit diagram of modified decoder logic 2900 used to control a SP6T RF switch 2950. Modified decoder logic 2900 includes NOR gates 2901-2906 and inverters 2911-2913, which are connected as illustrated. Each of NOR gates 2901-2902 has the same construction as NOR gate 601 (FIG. 7). As described in more detail below, 3-input NOR gates 2903-2906 have a logic structure that is similar to NOR gates 2901-2902. Modified decoder logic 2900 provides the control voltages V_{C1}-V_{C7} in response to the three input signals V_{A}, V_{B} and V_{C}. More specifically, modified decoder logic 2900 provides the control voltages V_{C1}-V_{C7} as set forth below in Table 2. Seven identical switch elements 191-197 are coupled to receive the control voltages V_{C1}-V_{C7}, respectively, as illustrated. Each of switch elements 191-196 is coupled to a corresponding one of RF sources 2921-2926 at corresponding ports PORT₁-PORT₆. Switch element 197 is coupled between switch elements 192 and 193. Switch element 197 is turned on when one of switch elements 193-196 is enabled, thereby coupling the enabled switch element to the antenna. In one embodiment, switch elements 193-196 are enabled during receive modes, and switch elements 191 and 192 are enabled during transmit modes.

TABLE 2

| V_{A} | V_{B} | V_{C} | V_{C1} | V_{C2} | V_{C3} | V_{C4} | V_{C5} | V_{C6} | V_{C7} |
|---|---|---|---|---|---|---|---|---|---|
| 0 | 1 | X | 1 | 0 | 0 | 0 | 0 | 0 | 0 |
| 1 | 1 | X | 0 | 1 | 0 | 0 | 0 | 0 | 0 |
| 1 | 0 | 1 | 0 | 0 | 1 | 0 | 0 | 0 | 1 |
| 0 | 0 | 1 | 0 | 0 | 0 | 1 | 0 | 0 | 1 |
| 0 | 0 | 0 | 0 | 0 | 0 | 0 | 1 | 0 | 1 |
| 1 | 0 | 0 | 0 | 0 | 0 | 0 | 0 | 1 | 1 |

FIG. 30 is a circuit diagram of 3-input NOR gate 2905 in accordance with one embodiment of the present invention. NOR gates 2903, 2904 and 2906 can have the same structure as NOR gate 2905. Because 3-input NOR gate 2905 (FIG. 30) is similar to 2-input NOR gate 601 (FIG. 7), similar elements in FIGS. 30 and 7 are labeled with similar reference numbers. Thus, 3-input NOR gate 2905 includes depletion mode transistor 701 and enhancement mode transistors 702-703 and 711-713, which are described above in connection with FIG. 7. In addition, 3-input NOR gate 2905 includes enhancement mode transistors 3001 and 3002.

Enhancement mode transistor 3001 has a source coupled to ground, a drain coupled to the drain of depletion mode transistor 701, and a gate coupled to receive the input signal V_{C}. Thus, enhancement mode transistor 3001 is connected in parallel with enhancement mode transistors 702 and 703.

Enhancement mode transistor 3002 has a source coupled to ground, a drain coupled to the drain of enhancement mode transistor 711, and a gate coupled to receive the input signal V_{C}. Thus, enhancement mode transistor 3002 is connected in parallel with enhancement mode transistors 712 and 713.

3-input NOR gate 2905 operates in a similar manner as 2-input NOR gate 601, except that 3-input NOR gate 2905 implements a logical NOR function of 3 inputs, rather than 2 inputs.

While FIG. 30 illustrates how to expand the 2-input NOR gate structure of the present invention to an N-input NOR gate structure, it is also possible to simplify the 2-input NOR gate structure of the present invention to implement an output buffer structure in accordance with another embodiment of the present invention.

FIG. 31 is a circuit diagram of an output buffer 3100 in accordance with another embodiment of the present invention. Output buffer 3100 provides the control voltage signal V_{C1} in response to input voltage V_{IN}. Because output buffer 3100 (FIG. 31) is similar to 2-input NOR gate 601 (FIG. 7), similar elements in FIGS. 31 and 7 are labeled with similar reference numbers. Thus, output buffer 3100 includes depletion mode transistor 701 and enhancement mode transistors 702, 711 and 713, which are described above in connection with FIG. 7.

Thus, when the input signal V_{IN} has a logic low state, enhancement mode transistors 702 and 713 are turned off, and depletion mode transistor 701 applies a logic high voltage to the gate of enhancement mode transistor 711. As a result, enhancement mode transistor 711 turns on, thereby pulling the V_{C1} control voltage up to the V_{DD} supply voltage.

When the input signal V_{IN} has a logic high state, enhancement mode transistors 702 and 713 are turned on, thereby pulling the V_{C1} control voltage and the gate of enhancement mode transistor 711 down to the ground supply voltage. Under these conditions, enhancement mode transistor 711 turns off, and minimal current flows through depletion mode transistor 701 and enhancement mode transistor 702, thereby resulting low current consumption. Note that output buffer 3100 performs an inverting function in the manner described above.

Although the invention has been described in connection with several embodiments, it is understood that this invention is not limited to the embodiments disclosed, but is capable of various modifications, which would be apparent to a person skilled in the art. Thus, the invention is limited only by the following claims.

1. A circuit for driving a radio frequency (RF) switch comprising:
a first enhancement mode transistor having a source configured to receive a first supply voltage and a drain coupled to the RF switch;
a depletion mode transistor having a source configured to receive the first supply voltage, and a drain and a gate coupled to a gate of the first enhancement mode transistor; and
a second enhancement mode transistor having a source configured to receive a second supply voltage, a drain coupled to the drain of the depletion mode transistor, and a gate configured to receive a first control signal.

2. The circuit of claim 1, further comprising a third enhancement mode transistor having a source configured to receive the second supply voltage, a drain coupled to the drain of the first enhancement mode transistor, and a gate configured to receive the first control signal.

3. The circuit of claim 2, further comprising:
a fourth enhancement mode transistor having a source configured to receive the second supply voltage, a drain coupled to the drain of the depletion mode transistor, and a gate configured to receive a second control signal; and
a fifth enhancement mode transistor having a source configured to receive the second supply voltage, a drain coupled to the drain of the first enhancement mode transistor, and a gate configured to receive the second control signal.

4. The circuit of claim 3, wherein the circuit is configured to perform a logical NOR operation in response to the first and second control signals.

5. The circuit of claim 3, further comprising:
a sixth enhancement mode transistor having a source configured to receive the second supply voltage, a drain coupled to the drain of the depletion mode transistor, and a gate configured to receive a third control signal; and
a seventh enhancement mode transistor having a source configured to receive the second supply voltage, a drain coupled to the drain of the first enhancement mode transistor, and a gate configured to receive the third control signal.

6. The circuit of claim 1, wherein the first enhancement mode transistor has a first channel width, and the depletion mode transistor has a second channel width, wherein the first channel width is greater than the second channel width.

7. The circuit of claim 6, wherein the first channel width is about five times greater than the second channel width.

8. The circuit of claim 6, wherein the second channel width is about 2 microns.

9. The circuit of claim 8, wherein the first channel width is about 10 microns.

10. The circuit of claim 1, wherein the first and second enhancement mode transistors and the depletion mode transistors are gallium arsenide (GaAs) metal semiconductor field effect transistors (MESFETs).

11. The circuit of claim 1, wherein the first and second enhancement mode transistors and the depletion mode transistors are gallium arsenide (GaAs) pseudomorphic high electron mobility transistors (PHEMTs).

12. The circuit of claim 1, wherein the depletion mode transistor is a multiple-gate gate transistor.

13. The circuit of claim 1, wherein the depletion mode transistor and the second enhancement mode transistor are sized such that a current on the order of about 5 to 10 micro-Amperes flows through the depletion mode transistor when a conductive path is enabled through the depletion mode transistor and the second enhancement mode transistor.

14. The circuit of claim 1, wherein the first enhancement mode transistor, the second enhancement mode transistor, the depletion mode transistor and the RF switch are all located on the same chip.

15. A method for controlling a radio frequency (RF) switch, comprising:
applying a first voltage to a gate of a first enhancement mode transistor through a depletion mode transistor; and
coupling the RF switch to a first voltage supply terminal through the first enhancement mode transistor when the first voltage is applied to the gate of the first enhancement mode transistor.

16. The method of claim 15, further comprising:
applying a second voltage to the gate of the first enhancement mode transistor through a second enhancement mode transistor; and
de-coupling the RF switch from the first voltage supply terminal with the first enhancement mode transistor when the second voltage is applied to the gate of the first enhancement mode transistor.

17. The method of claim 16, wherein the step of applying the second voltage to the gate of the first enhancement mode transistor comprises applying a control signal to a gate of the second enhancement mode transistor, thereby enabling the second enhancement mode transistor to couple the gate of the first enhancement mode transistor to a second voltage supply terminal.

18. The method of claim 17, wherein the step of de-coupling the RF switch from the first voltage supply terminal comprises turning off the first enhancement mode transistor in response to the second voltage.

19. The method of claim 16, wherein the depletion mode transistor is always on.

20. The method of claim 16, wherein the step of applying the second voltage to the gate of the first enhancement mode transistor comprises creating a conductive path through the second enhancement mode transistor, between the gate of the first enhancement transistor and a second voltage supply terminal.

21. The method of claim 20, wherein the step of applying the second voltage to the gate of the first enhancement mode transistor comprises creating a conductive path between the first and second voltage supply terminals through the depletion mode transistor and the second enhancement mode transistor.

22. The method of claim 21, wherein the conductive path draws approximately 5 to 10 micro-Amperes of current.

23. The method of claim 16, further comprising coupling the RF switch to a second voltage supply terminal through a third enhancement mode transistor when the second voltage is applied to the gate of the first enhancement mode transistor.

24. The method of claim 15, wherein a voltage provided to the RF switch via the first enhancement mode transistor and the first voltage supply terminal exhibits a rise time of about 49 nanoseconds.

25. The method of claim 15, further comprising selecting the sizes of the first enhancement mode transistor and the depletion mode transistor such that the first enhancement mode transistor has a larger width than the depletion mode transistor.

26. The method of claim 15, further comprising fabricating the first enhancement mode transistor, the depletion mode transistor and the RF switch using a gallium-arsenide process technology.

27. The method of claim 15, further comprising fabricating the first enhancement mode transistor, the depletion mode transistor and the RF switch on the same chip.

28. A circuit for driving a radio frequency (RF) switch comprising:
a first enhancement mode transistor having a source configured to receive a first supply voltage and a drain coupled to the RF switch;
a depletion mode transistor having a source configured to receive the first supply voltage, and a drain and a gate coupled to a gate of the first enhancement mode transistor;
a first plurality of enhancement mode transistors, each having a source configured to receive a second supply voltage, a drain coupled to the drain of the depletion mode transistor, and a gate configured to receive a corresponding one of a plurality of control signals; and
a second plurality of enhancement mode transistors, each having a source configured to receive the second supply voltage, a drain coupled to the drain of the first enhancement mode transistor, and a gate configured to receive a corresponding one of the plurality of control signals.
